(19) United States
(12) Patent Application Publication
(10) Pub. No.: US 2018/0211639 A1
(43) Pub. Date: Jul. 26, 2018

(54) STRINGED MUSICAL INSTRUMENT

(71) Applicant: YAMAHA CORPORATION, Hamamatsu-shi (JP)

(72) Inventor: Hirotaka NIIRO, Tokyo-to (JP)

(21) Appl. No.: 15/926,212

(22) Filed: Mar. 20, 2018

Related U.S. Application Data
(63) Continuation of application No. PCT/JP2016/077414, filed on Sep. 16, 2016.

(30) Foreign Application Priority Data
Oct. 5, 2015 (JP) 2015-197756

(51) Int. Cl. G10D 3/06; G10D 1/08

(52) U.S. Cl. CPC G10D 3/06; G10D 1/085

(57) ABSTRACT

A stringed musical instrument includes: a body; a neck extending from the body in one direction, a string being tensioned at the neck and including a first end portion to be held by the body and a second end portion to the held by the neck; and a rod provided in the neck and extending in a neck extending direction. The neck includes: a first neck portion to be held by the body; and a second neck portion provided on an opposite side of the first neck portion from the body in the neck extending direction. The second neck portion holds the second end portion of the string and is attachable to and detachable from the first neck portion. Each of the first neck portion, the second neck portion, and the body is formed with an insertion hole in which the rod is insertable in the neck extending direction.

### TECHNICAL FIELD

The present invention relates to a stringed musical instrument including a neck and a body and in particular to a technique for making the stringed musical instrument compact.

### BACKGROUND ART

A bendable guitar is conventionally developed to increase portability and storagebility. For example, there is a guitar constructed such that a neck is bendable with respect to a body (for example, Patent Document 1, etc.). In the guitar disclosed in Patent Document 1, the neck and the body are coupled to each other by a hinge. Thus, the guitar is foldable such that the neck is moved to a front side of the body. A guitar disclosed in Patent Document 2 is provided with a hinge on a back side of a neck, making the neck and a fingerboard foldable to a back side at a middle portion of the neck and the fingerboard in a direction in which the neck and the fingerboard extend.

### Prior Art Documents

### PATENT DOCUMENTS

Patent Document 1: Japanese Patent Application Publication No. 5635606
Patent Document 2: Japanese Registered Utility Model No. 3174638 (e.g., paragraph 0023 and FIG. 5)

### SUMMARY OF THE INVENTION

### Problem to be Solved by the Invention

In the guitar disclosed in Patent Document 1, there is a possibility that the folded neck extends toward the body and protrudes to a rear side of the body. In the guitar disclosed in Patent Document 2, an additional neck is fitted in a receiving member provided at a distal end of one neck, whereby the entire neck is extended. This receiving member protrudes downward from a lower surface of the neck, which may lead to a larger width (thickness) of the neck in the up and down direction. Thus, the construction of each guitar has room for improvements in size reduction.

The present disclosure is made to solve the problem, and an object of the present disclosure is to provide a stringed musical instrument that can be made compact.

### Means for Solving Problem

A stringed musical instrument according to the present disclosure comprises: a body; a neck extending from the body in one direction, a string being tensioned at the neck, the string comprising a first end portion and a second end portion, the body holding the first end portion of the string, the neck holding the second end portion of the string; and a rod provided in the neck and extending in a direction in which the neck extends, wherein the neck comprises: a first neck portion to be held by the body; and a second neck portion provided on an opposite side of the first neck portion from the body in the direction in which the neck extends, the second neck portion holding the second end portion of the string, the second neck portion being attachable to and detachable from the first neck portion, and wherein each of the first neck portion, the second neck portion, and the body is formed with an insertion hole in which the rod is insertable in the direction in which the neck extends.

The neck of the stringed musical instrument is disassemblable, in the direction in which the neck extends, into the first neck portion to be held by the body and the second neck portion to be attached to the first neck portion. The rod is provided in the neck so as to extend in the direction in which the neck extends. Each of the first neck portion, the second neck portion, and the body has the insertion hole for insertion of the rod. With this construction, the rod is inserted in the insertion holes of the three components, enabling assembly of the stringed musical instrument including the three components coupled to one another. In this stringed musical instrument, the rod is pulled out of the insertion holes in the assembled state, enabling disassembly of the first neck portion and the second neck portion. Accordingly, the disassembly of the neck into the plurality of the components after the rod is pulled out makes the entire stringed musical instrument compact.

The stringed musical instrument according to the present disclosure may be configured such that the rod comprises: a plurality of divided rod portions extending in the direction in which the neck extends; and a connector configured to connect the plurality of divided rod portions to each other and such that the rod is inserted in the insertion hole in a state in which the plurality of divided rod portions are connected to each other by the connector. Since the rod is divided into the plurality of divided rod portions, the rod can be made compact. Also, the stringed musical instrument according to the present disclosure may be configured such that the connector is configured to connect the plurality of divided rod portions to each other so as to prevent the plurality of divided rod portions from being seprated from each other. Since the plurality of divided rod portions are connected to each other by the connector so as not to be separated from each other, it is possible to secure the first neck portion and the second neck portion to each other. The stringed musical instrument according to the present disclosure may be configured such that the rod comprises: a first rod portion extending in the direction in which the neck extends; a rotation shaft provided at one end portion of the first rod portion in the direction in which the neck extends, the rotation shaft being insertable in the first rod portion in a direction perpendicular to the direction in which the neck extends; and a second rod portion extending in the direction in which the neck extends, the second rod portion being pivotably held by the rotation shaft at the one end portion of the first rod portion.

The rod of the stringed musical instrument includes the first rod portion and the second rod portion arranged next to each other in the direction in which the neck extends. The second rod portion is pivotable about the rotation shaft of the first rod portion. This configuration makes the rod compact by folding the rod pulled out of the neck and the body.

The stringed musical instrument according to the present disclosure may be configured such that the rotation shaft is disposed on one side, in the direction in which the neck extends, of a portion at which the first neck portion and the second neck portion are coupled to each other, in a state in which each of the first rod portion and the second rod portion is inserted in the insertion hole.

A portion of the neck at which the first neck portion and the second neck portion are coupled to each other is located at a boundary of two portions of the neck, into which the neck is divided. Thus, there is a possibility that the stiffness of the coupled portion is lower than the other portion of the neck. Likewise, since the portion of the rod at which the first rod portion and the second rod portion are coupled is pivotable by the rotation shaft, there is a possibility that the stiffness of the coupled portion is lower than that of the other portion of the rod. In the stringed musical instrument, in contrast, the positions of the coupled portions in the neck and the rod are different from each other, enabling the rod to well increase the stiffness of the neck.

The stringed musical instrument according to the present disclosure may be configured such that the body comprises a first engaged portion and such that the rod comprises a first engaging portion provided at one of opposite end portions of the rod, which one is nearer to the body than the other, and the first engaging portion is engaged with the first engaged portion in a state in which the rod is inserted in the insertion hole of the body.

In the stringed musical instrument described above, the rod can be attached to the body by inserting the rod into the insertion hole and engaging the first engaging portion with the first engaged portion of the body. This enables the rod to be firmly secured to the body.

The stringed musical instrument according to the present disclosure may be configured such that the rod is formed of a metal material and such that at least one of the first neck portion, the second neck portion, and the body comprises a cylindrical member secured in the insertion hole and formed of a metal material, and the rod is insertable in the cylindrical member.

In the stringed musical instrument described above, a component formed of metal is used for the rod, resulting in increased stiffness of the neck. Here, in the case where the neck is formed of wood, for example, the neck may be damaged by contact with the rod when the rod formed of metal is inserted into and removed from the insertion hole. To solve this problem, in the stringed musical instrument, the cylindrical member formed of metal is provided in the insertion hole, thereby protecting the neck from contact with the rod.

The stringed musical instrument according to the present disclosure may further comprise a neck fastening mechanism provided on one of opposite end portions of the neck in the direction in which the neck extends, which one is farther from the body than the other in the direction in which the neck extends and may be configured such that the rod comprises: a first engaging portion provided on one of opposite end portions of the rod, which one is nearer to the body than the other, the first engaging portion being engageable with a first engaged portion formed at the body; and a second engaging portion provided on the other of the opposite end portions of the rod, which is farther from the body than the one, the second engaging portion being engageable with a second engaged portion formed at the neck fastening mechanism, and such that the neck fastening mechanism comprises: an engaging portion at which the second engaged portion is formed; and a pressing portion configured to press the neck toward the body in a state in which the first engaging portion is engaged with the first engaged portion, and the second engaging portion is engaged with the second engaged portion. Also, the stringed musical instrument according to the present disclosure may be configured such that the engaging portion comprises a shaft having a columner shape and extending in a direction perpendicular to the direction in which the neck extends, the shaft comprising a handle rotation shaft protruding outward from each of end faces of the shaft in an axial direction of the shaft, and such that the pressing portion comprises a handle swingably held by the handle rotation shaft, the handle being eccentric with respect to the handle rotation shaft, the handle being configured to press the second neck portion toward the first neck portion.

In the stringed musical instrument, the shaft of the neck fastening mechanism is engaged with the second engaging portion of the rod inserted in the neck. The distance between the handle of the neck fastening mechanism and the second neck portion in the direction in which the neck extends is changed in accordance with a position of the engagement. For example, the shaft is engaged with the second engaging portion until the handle and the second neck portion are brought into contact with each other. When the handle is swung relative to the handle rotation shaft in this state, the eccentric handle presses the second neck portion toward the first neck portion. With this construction, a user of the stringed musical instrument can swing the handle to reduce relative positional misalignment between the rod and the neck.

The stringed musical instrument according to the present disclosure may further comprise a neck fastening mechanism provided at one of opposite end portions of the second neck portion in the direction in which the neck extends, the other of the opposite end portions being to be held by the first neck portion and may be configured such that the neck fastening mechanism comprises: a fastened portion to be fastened to one of opposite end portions of the rod, which one is nearer to the second neck portion than the other; and a pressing portion configured to press the neck toward the body in a state in which the fastened portion is fastened to the one of the opposite end portions of the rod, which one is nearer to the second neck portion than the other. Also, the stringed musical instrument according to the present disclosure may be configured such that the fastened portion comprises a shaft having a columner shape and extending in a direction perpendicular to the direction in which the neck extends, the shaft being fastened to the one of the opposite end portions of the rod, which one is nearer to the second neck portion than the other, the shaft comprising a handle rotation shaft protruding outward from each of end faces of the shaft in an axial direction of the shaft, and such that the pressing portion comprises a handle swingably held by the handle rotation shaft, the handle being eccentric with respect to the handle rotation shaft, the handle being configured to press the second neck portion toward the first neck portion.

In the stringed musical instrument described above, when the handle is swung relative to the handle rotation shaft, the eccentric handle presses the second neck portion toward the first neck portion. With this construction, a user of the stringed musical instrument can swing the handle to reduce relative positional misalignment between the rod and the neck. Also, the shaft of the neck fastening mechanism is secured to the end portion of the rod inserted in the neck, which end portion is near the second neck portion. With this construction, the user can, for example, operate the handle to insert and remove the rod into or from the neck of the rod and rotate the rod. In particular, in the case where the first engaged portion is provided at the body, and the first engaging portion is provided at the end portion of the rod which is near the body, the user can easily remove the rod by rotating the handle to remove the first engaging portion from the first engaged portion and pulling the handle to remove the rod from the neck.

A stringed musical instrument according to the present disclosure comprises: a body; and a neck extending from the body in one direction, a string being tensioned at the neck, the string comprising a first end portion and a second end portion, the body holding the first end portion of the string, the neck holding the second end portion of the string, wherein the neck comprises: a first neck portion held by the body; and a second neck portion provided on an opposite side of the first neck portion from the body in a direction in which the neck extends, the second neck portion holding the second end portion of the string, the second neck portion being attachable to and detachable from the first neck portion, wherein one of the first neck portion and the second neck portion comprises a first protruding portion protruding toward the other of the first neck portion and the second neck portion, and wherein the other of the first neck portion and the second neck portion comprises a first recess in which the first protruding portion is fittable.

The neck of the stringed musical instrument described above is disassemblable, in the direction in which the neck extends, into the first neck portion to be held by the body and the second neck portion to be attached to the first neck portion. One of the first neck portion and the second neck portion includes the first protruding portion protruding toward the other. The other of the first neck portion and the second neck portion has the first recess in which the first protruding portion is fittable. In the stringed musical instrument described above, the first protruding portion is fitted in the first recess, whereby the first neck portion and the second neck portion coupled to each other and assembled. In the stringed musical instrument described above, the first protruding portion protrudes in the direction in which the neck extends, resulting in reduced thickness of the neck. In the stringed musical instrument described above, the user can pull the first protruding portion out of the first recess in the assembled state to disassemble the first neck portion and the second neck portion. Accordingly, the disassembly of the neck into the plurality of the components makes the entire stringed musical instrument compact.

The stringed musical instrument according to the present disclosure may be configured such that one of the body and the first neck portion comprises a second protruding portion protruding toward the other of the body and the first neck portion and such that the other of the body and the first neck portion comprises a second recess in which the second protruding portion is fittable.

In this construction, the user can fit the second protruding portion in the second recess to easily couple the body and the first neck portion to each other.

The stringed musical instrument according to the present disclosure may be configured such that the body comprises: a first body portion configured to hold the first neck portion; a second body portion provided on an opposite side of the first body portion from the first neck portion in the direction in which the neck extends; a bridge provided at the second body portion and configured to be engaged with the first end portion of the string; and a swing member configured to couple the first body portion and the second body portion to each other and hold the second body portion such that the second body portion is swingable relative to the first body portion, from a state in which the string is tensioned, in a direction in which the bridge is brought closer to the first body portion.

Here, since tension of the string is applied to the neck in the state in which the string is tensioned, there is a possibility that disassembly of the first neck portion and the second neck portion is difficult. In view of this, the body is divided into the first body portion and the second body portion in the stringed musical instrument described above. Also, the swing member can swing the second body portion toward the first body portion to bring the bridge closer to the first body portion, enabling loosening of the string. Accordingly, the neck can be disassembled in the state in which the string is loosened, facilitating disassembly.

The stringed musical instrument according to the present disclosure may be configured such that the second neck portion comprises a neck-side engaging portion provided at one of opposite end portions of the second neck portion in the direction in which the neck extends, the other of the opposite end portions being to be held by the first neck portion, the neck-side engaging portion being configured to be engaged with the second end portion of the string, and such that the bridge comprises: a main body portion; and a tension adjusting screw engaged with the first end portion of the string and configured to adjust tension of the string in accordance with a position at which the tension adjusting screw is engaged with the main body portion.

The stringed musical instrument described above does not include a peg mechanism for tightening or loosening the string on the second neck portion. Instead, the stringed musical instrument is capable of adjusting the tension of the string in accordance with a position at which the tension adjusting screw of the bridge provided on the body is engaged with the main body portion. The neck not including the peg mechanism can reduce a volume after disassembly of the neck, enabling further size reduction.

### EFFECT OF THE INVENTION

According to a stringed musical instrument according to the present disclosure, it is possible to make the entire musical instrument compact.

### BRIEF DESCRIPTION OF THE DRAWINGS

FIG. 1 is a top view of a guitar according to an embodiment.

FIG. 2 is a side view of the guitar.

FIG. 3 is a side view of a body, illustrating a state in which a second body portion is swung with respect to a first body portion.

FIG. 4 is an exploded perspective view of the first body portion, a first neck portion, and a second neck portion.

FIG. 5 is a side view of a rod.

FIG. 6 is a perspective view of the second neck portion on which a neck fastening mechanism is mounted.

### EMBODIMENT

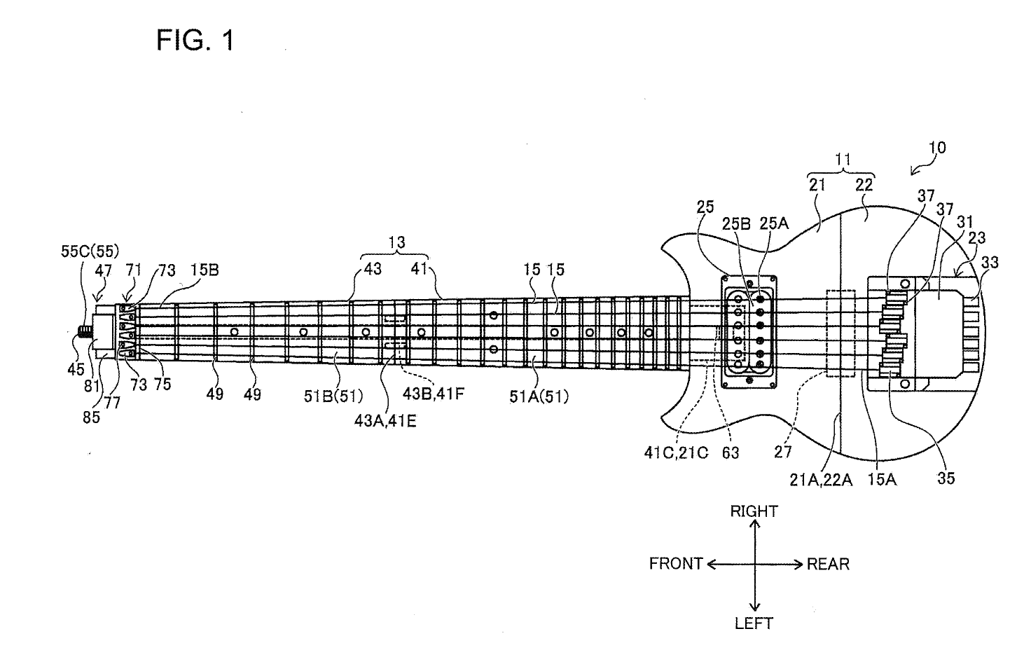

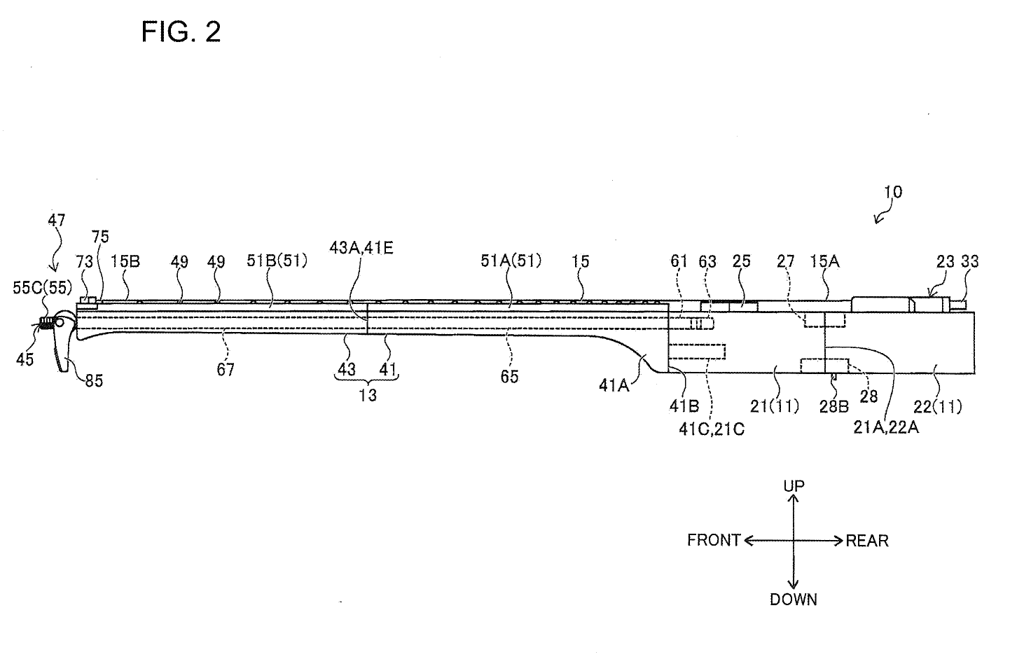

Hereinafter, there will be described a guitar 10 as one example of a stringed musical instrument according to one embodiment. The guitar 10 according to the present embodiment can be assembled and disassembled. FIG. 1 is a top view of the guitar 10, illustrating a state in which the guitar 10 is assembled. FIG. 2 is a side view of the guitar 10, illustrating its assembled state. The guitar 10 is what is called an electric guitar and includes a body 11 and a neck 13 coupled to the body 11.

The neck 13 extends in one direction, and one end portion of the neck 13 is secured to the body 11. As illustrated in FIGS. 1 and 2, a distal end side of the neck 13 is defined as a front side, and a body side of the neck 13 as a rear side. A direction perpendicular to the front and rear direction and substantially parallel with surfaces of the neck 13 and the body 11 is defined as the right and left direction. A direction perpendicular to the front and rear direction and the right and left direction (a direction perpendicular to the sheet surface of FIG. 1) is defined as the up and down direction. A direction in which the neck 13 extends is parallel with the front and rear direction.

### Construction of Body 11

There will be explained a construction of the body 11. The body 11 includes a first body portion 21, a second body portion 22, a bridge 23, and a pickup 25. The body 11 is divided into the first body portion 21 and the second body portion 22 arranged next to each other in the front and rear direction. The first body portion 21 and the second body portion 22 may be formed of wood such as maple, alder, and mahogany.

A string engaging portion 71 is provided on a distal end of the neck 13. Six strings 15 are tensioned between the string engaging portion 71 and the bridge 23 of the body 11. The bridge 23 includes a bridge main body 31, six tension adjusting screws 33, six saddles 35, and height adjusting screws 37. The bridge main body 31 is mounted along a surface of the second body portion 22. The bridge main body 31 is substantially shaped like a box with a small thickness in the up and down direction.

The tension adjusting screws 33 are provided so as to correspond to the respective strings 15. These tension adjusting screws 33 are engaged with a rear end of the bridge main body 31. Each of the tension adjusting screws 33 engages a ball end, not illustrated, of a first end portion 15A of a corresponding one of the strings 15. A user of the guitar 10 can rotate each of the tension adjusting screws 33 in a direction in which the tension adjusting screw 33 is tightened, for example, to move the ball end frontward (toward the neck 13) and loosen the strings 15. On the other hand, the user can rotate the tension adjusting screw 33 in a direction in which the tension adjusting screw 33 is loosened, to move the ball end rearward and increase a tension applied to the string 15.

The saddles 35 are provided so as to correspond to the respective strings 15. The saddles 35 support the respective strings 15 from a lower side thereof to keep the height level of the strings 15 from a fingerboard 51 of the neck 13. Two of the height adjusting screws 37 are engaged with a corresponding one of the saddles 35 in the up and down direction. One example of the height adjusting screws 37 is hexagon head screws. The user can tighten each of the height adjusting screws 37, for example, to reduce the height level of a corresponding one of the saddles 35, i.e., the height level of a corresponding one of the strings 15. Also, the user can loosen each of the height adjusting screws 37 to increase the height level of the corresponding string 15. Accordingly, the user can adjust the tension adjusting screws 33 and the height adjusting screws 37 to tune and adjust the respective strings 15.

The pickup 25 is mounted on an upper surface of the first body portion 21. The pickup 25 includes: magnets 25A each shaped like a rod and located just under a corresponding one of the strings 15; and a bobbin 25B that retains the magnets 25A. The pickup 25 detects vibration of each string 15 as electromagnetic induction, converts the vibration to an electric signal, and outputs it.

The first body portion 21 and the second body portion 22 are coupled to each other by a swing member 27. The swing member 27 is a hinge, for example, and holds the second body portion 22 so as to allow the second body portion 22 to be swung in the up and down direction with respect to the first body portion 21. In the state in which the body 11 is assembled as illustrated in FIGS. 1 and 2, a rear end surface 21A of the first body portion 21 and a front end surface 22A of the second body portion 22 are in contact with or close to each other in the front and rear direction. The swing member 27 is provided inside an upper portion of the first body portion 21 and the second body portion 22 in a boundary area between the first body portion 21 and the second body portion 22 such that the swing member 27 is not exposed from upper and lower surfaces of the first body portion 21 and the second body portion 22, and the swing member 27 cannot be viewed from the outside in the state in which the body 11 is assembled.

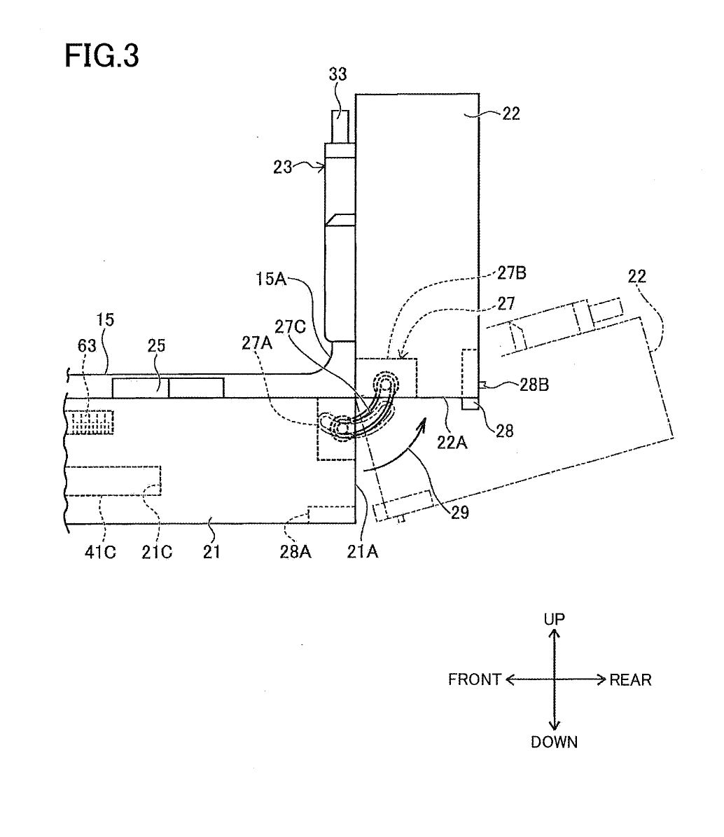

FIG. 3 is a side view of the body 11, illustrating a state in which the second body portion 22 has been swung with respect to the first body portion 21. The swing member 27 includes: a first bearing 27A mounted on the rear end surface 21A; a second bearing 27B mounted on the front end surface 22A; and a swing shaft 27C that couples the first bearing 27A and the second bearing 27B to each other. The swing member 27 can be swung with change of position of the swing shaft 27C to swing the second bearing 27B with respect to the first bearing 27A. A lock mechanism, not illustrated, enables change in the angle of the swing member 27 by every predetermined angle. The swing of the swing member 27 swings the second body portion 22 with respect to the first body portion 21 in a direction in which the bridge 23 is brought closer to the pickup 25 provided on the first body portion 21, i.e., a direction indicated by arrow 29 in FIG. 3. This construction allows the user to swing the second body portion 22 to loosen the strings 15 tensioned between the string engaging portion 71 and the bridge 23, facilitating disassembly of the neck 13 which will be described below.

The body 11 includes a pickup switch, not illustrated, and a connector, not illustrated, for connection of an acoustic cable, not illustrated. For simple internal construction, the guitar 10 according to the present embodiment is configured such that the electric signal obtained by the pickup 25 is directly output to the outside without execution of signal processing. Specifically, the body 11 does not include a sound-volume adjusting circuit for damping the electric signal obtained by the pickup 25, a processing circuit for processing the electric signal, or other similar circuits. Thus, the body 11 is not provided with switches such as a volume control and a tone control. This construction results in weight reduction of the guitar 10 and smaller number of components provided in the body 11 such as signal cables, which reduces a malfunction such as a broken wires caused by bending of the guitar 10. It is noted that the body 11 may include other circuits such as a processing circuit for changing a sound volume and a tone color. In the case where the body 11 includes such circuits, the body 11 may be constructed, for example, such that the circuits such as the processing circuit are provided inside the first body portion 21 to reduce the number of signal cables connecting between the first body portion 21 and the second body portion 22.

### Construction of Neck 13

There will be next explained the neck 13. The neck 13 includes a first neck portion 41, a second neck portion 43, a rod 45, and a neck fastening mechanism 47. The neck 13 is divided into the first neck portion 41 and the second neck portion 43 arranged next to each other in the front and rear direction. The second body portion 22, the first body portion 21, the first neck portion 41, and the second neck portion 43 are assembled so as to be arranged in this order from a rear side. The first neck portion 41 and the second neck portion 43 may be formed of wood such as maple, for example.

The fingerboard 51 is mounted on an upper surface of the neck 13. The fingerboard 51 includes a plurality of frets 49 (23 frets in the present embodiment). The fingerboard 51 may be formed of wood such as ebony. The fingerboard 51 is divided into a first fingerboard 51A and a second fingerboard 51B respectively corresponding in size to the first neck portion 41 and the second neck portion 43. The first fingerboard 51A is provided on the first neck portion 41, and the second fingerboard 51B on the second neck portion 43.

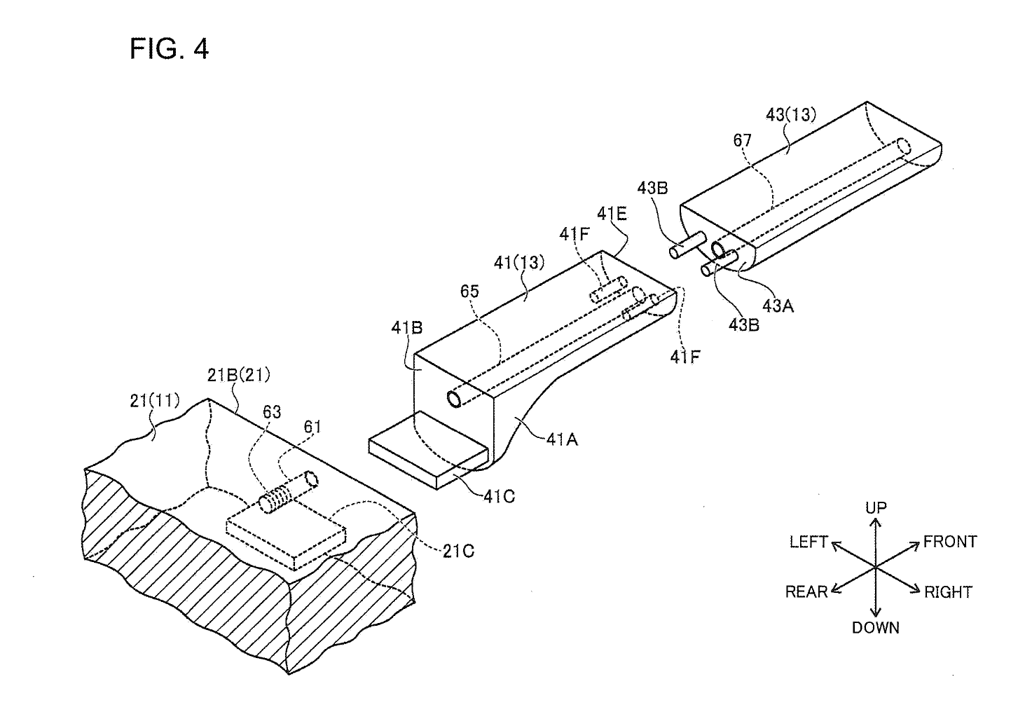

FIG. 4 is an exploded perspective view of the neck 13 detached from the body 11, schematically illustrating each component. It is noted that FIG. 4 omits illustration of components such as the neck fastening mechanism 47, the fingerboard 51, and the pickup 25 for easy understanding.

As illustrated in FIGS. 2 and 4, a cross-sectional shape of the neck 13 which is taken along a plane extending along the up and down direction and the right and left direction is a semicircular shape protruding downward in an arc shape. A rear end portion of the neck 13, i.e., a rear end portion of the first neck portion 41 serves as a heel 41A that is mounted on a front end portion 21B of the first body portion 21. When viewed in the right and left direction, the heel 41A is inclined so as to be lower at its rear portion than its front portion from a main body portion of the neck 13 having the semicircular shape.

A rear end surface 41B of the heel 41A has a substantially rectangular shape elongated in the up and down direction and has an arc shape in its lower end portion. The length of the rear end surface 41B in the up and down direction is substantially equal to that of the front end portion 21B of the first body portion 21 in the up and down direction. The lower end portion of the heel 41A is provided with a protrusion 41C protruding rearward. The protrusion 41C is shaped like a plate elongated in the front and rear direction and the right and left direction. The protrusion 41C may be formed by cutting a single wood material so as to form the first neck portion 41 and the protrusion 41C which are integral with each other, for example. Alternatively, the protrusion 41C provided independently of the first neck portion 41 may be fitted into a hole of the heel 41A and bonded to the heel 41A.

The front end portion 21B of the first body portion 21 has a recess 21C that is recessed rearward so as to correspond to the position and the shape of the protrusion 41C provided on the heel 41A. The first neck portion 41 is mounted on the first body portion 21 in a state in which the protrusion 41C is fitted in the recess 21C. The heel 41A is mounted on the first body portion 21 in a state in which the rear end surface 41B is in contact with a front end surface of the front end portion 21B. It is noted that the first neck portion 41 and the first body portion 21 may be constructed such that the protrusion 41C is fitted in and secured to the recess 21C by a fastener such as a bolt.

The second neck portion 43 is elongated in the front and rear direction and has a semicircular shape in cross section. The second neck portion 43 is provided with a pair of joint rods 43B that protrude rearward from a rear end surface 43A in a direction parallel with the front and rear direction. Each of the joint rods 43B has a circular cylindrical shape. The joint rods 43B are arranged such that a third cylindrical member 67 for insertion of the rod 45, which will be described below, is interposed between the joint rods 43B in the right and left direction. The joint rods 43B may be formed by cutting a single wood material so as to form the second neck portion 43 and the joint rods 43B which are integral with each other, for example. Alternatively, the joint rods 43B provided independently of the second neck portion 43 may be respectively fitted into holes of the rear end surface 43A and bonded to the rear end surface 43A.

The first neck portion 41 has a pair of joint holes 41F each having an opening in a front end surface 41E of the first neck portion 41. Each of the joint holes 41F is shaped like a cylinder that corresponds to the shape of one of the joint rods 43B provided on the second neck portion 43. The joint holes 41F are formed so as to respectively correspond to the positions of the joint rods 43B and arranged such that a second cylindrical member 65 for insertion of the rod 45 is interposed between the joint holes 41F in the right and left direction. The second neck portion 43 is mounted on the first neck portion 41 in a state in which the joint rods 43B are fitted in the respective joint holes 41F. The second neck portion 43 is mounted on the first neck portion 41 in a state in which the rear end surface 43A is in contact with the front end surface 41E of the first neck portion 41.

### Construction of Rod 45

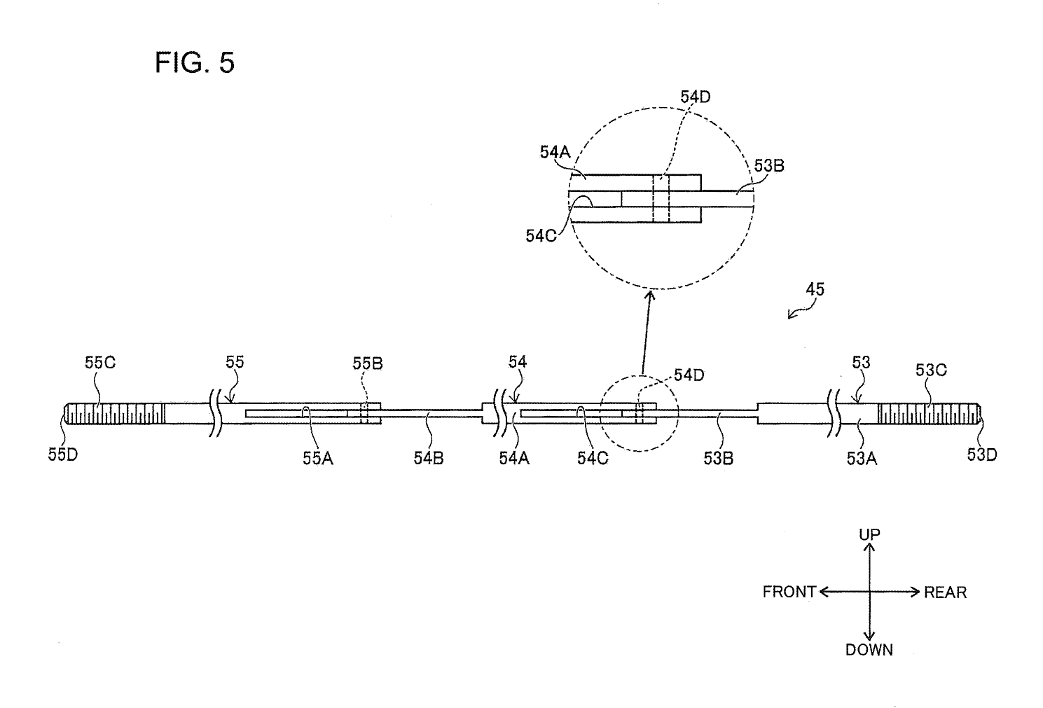

The rod 45 is inserted in the neck 13 in the front and rear direction. Long application of tension of the strings 15 may curve the neck 13 and the fingerboard 51 like a bow with respect to the strings 15, for example. The rod 45 increases the stiffness of the neck 13 to prevent the neck 13 and the fingerboard 51 from being curved. The rod 45 may be formed of metal, carbon materials, or other materials, for example. Examples of the metal include carbon steel, stainless steel (SUS), duralumin, and titanium. FIG. 5 is a side view of the rod 45. As illustrated in FIG. 5, the rod 45 is substantially shaped like a circular cylinder extending in a direction parallel with the front and rear direction. The rod 45 includes a first rod portion 53, a second rod portion 54, and a third rod portion 55 which are coupled to each other. The first rod portion 53, the second rod portion 54, and the third rod portion 55 are arranged in this order from a rear side in a state in which the first to third rod portions 53-55 are inserted in the neck 13.

The first rod portion 53 is to be inserted in a first cylindrical member 61 of the first body portion 21 and the second cylindrical member 65 (see FIG. 4) of the first neck portion 41. The first rod portion 53 includes a rod circular cylindrical portion 53A and a rod flat board portion 53B. As illustrated in FIG. 4, the first cylindrical member 61 is provided inside the first body portion 21. The first rod portion 53 is to be inserted in the first cylindrical member 61 over the recess 21C. The first cylindrical member 61 is shaped like a cylinder having an outside diameter slightly larger than that of the rod 45. The rod 45 is insertable in the first cylindrical member 61 with a predetermined clearance. An outer circumferential surface of the first cylindrical member 61 is bonded to the first body portion 21, for example.

A nut 63 is provided inside the first body portion 21 at a rear end portion of the first cylindrical member 61. The nut 63 is a buried nut such as an ONIME nut (registered trademark), for example. The nut 63 is disposed so as to communicate with an opening formed in a rear end of the first cylindrical member 61. Claws provided on an outer circumferential surface of the nut 63 are engaged with the first body portion 21 formed of wood, for example, whereby the nut 63 is secured to the first body portion 21.

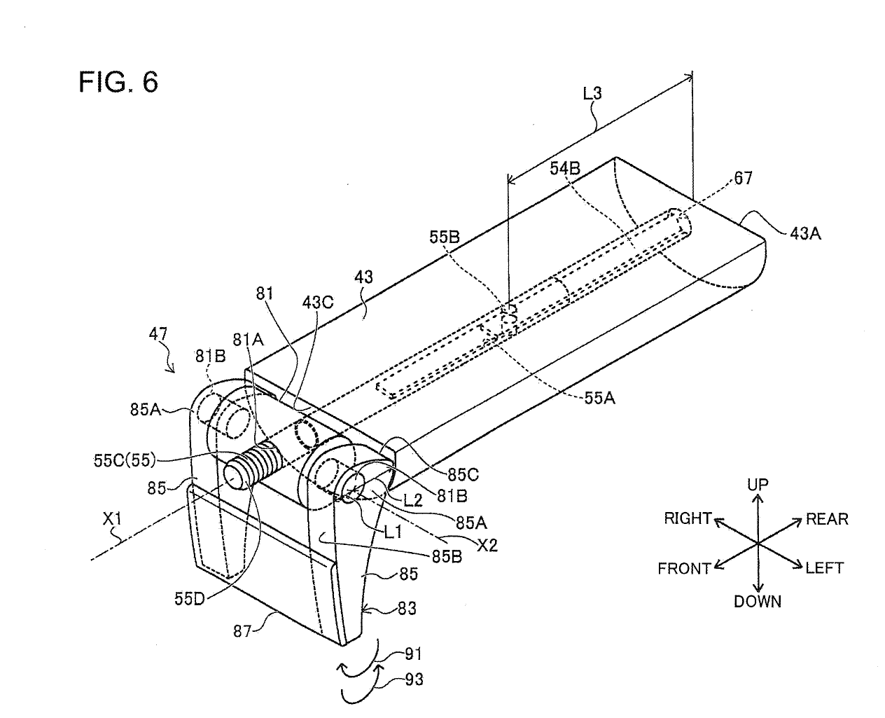

As illustrated in FIG. 5, the rod circular cylindrical portion 53A of the first rod portion 53 is substantially shaped like a circular cylinder. A rear end of the rod circular cylindrical portion 53A has an engaging portion 53C with a thread corresponding to a pitch of the nut 63. A distal end portion of the engaging portion 53C has a chamfered portion 53D chamfered and rounded to facilitate the insertion of the rod 45 into the first cylindrical member 61. The first rod portion 53 is inserted into the first cylindrical member 61, and the engaging portion 53C is engaged with the nut 63, whereby the rod 45 is secured to the first body portion 21. It is noted that the rod 45 is secured to the first body portion 21 while rotating during the engagement of the engaging portion 53C with the nut 63. An orientation (angle) of the rod 45 in FIGS. 5 and 6 which will be described below is one example and changed as needed in accordance with its rotational position.

The second rod portion 54 is provided in front of and next to the first rod portion 53 and includes a rod circular cylindrical portion 54A and a rod flat board portion 54B. The second rod portion 54 is to be inserted in the second cylindrical member 65 of the first neck portion 41 and the third cylindrical member 67 of the second neck portion 43. As illustrated in FIG. 4, the second cylindrical member 65 for insertion of the first rod portion 53 and the second rod portion 54 is provided inside the first neck portion 41 at a position interposed between the joint holes 41F in the right and left direction. The second cylindrical member 65 is shaped like a cylinder having an outside diameter slightly larger than that of the rod 45. The rod 45 is insertable in the second cylindrical member 65 with a predetermined clearance. The length of the second cylindrical member 65 in the front and rear direction is equal to that of the first neck portion 41 in the front and rear direction. The second cylindrical member 65 is bonded to the first neck portion 41, for example.

Likewise, the third cylindrical member 67 for insertion of the second rod portion 54 and the third rod portion 55 is provided inside the second neck portion 43 at a position interposed between the joint rods 43B in the right and left direction. The third cylindrical member 67 is shaped like a cylinder having an outside diameter slightly larger than that of the rod 45. The rod 45 is insertable in the third cylindrical member 67 with a predetermined clearance. The length of the third cylindrical member 67 in the front and rear direction is equal to that of the second neck portion 43 in the front and rear direction. The third cylindrical member 67 is bonded to the second neck portion 43, for example. Each of the first to third cylindrical members 61, 65, 67 may be formed of metal, carbon materials, or other materials, for example. Examples of the metal include carbon steel, stainless steel (SUS), duralumin, and titanium.

As illustrated in FIG. 5, the rod flat board portion 53B of the first rod portion 53 is provided continuously to a front end portion of the rod circular cylindrical portion 53A. The rod flat board portion 53B is shaped like a plate having a thickness smaller than the outside diameter of the rod circular cylindrical portion 53A. The rod circular cylindrical portion 54A of the second rod portion 54 is substantially shaped like a circular cylinder having an insertion groove 54C at its central portion in the up and down direction, and this insertion groove 54C extends frontward from a rear end of the rod circular cylindrical portion 54A. The width of the insertion groove 54C in the up and down direction corresponds to the thickness of the rod flat board portion 53B of the first rod portion 53.

As illustrated in the enlarged view in FIG. 5, a rotation shaft 54D is inserted in a rear end portion of the rod circular cylindrical portion 54A. The rotation shaft 54D extends through the insertion groove 54C in the up and down direction. Opposite end portions of the rotation shaft 54D in its axial direction are fixed to the rod circular cylindrical portion 54A. The opposite ends of the rotation shaft 54D in the axial direction are fixed to the rod circular cylindrical portion 54A by welding, pressing, or other similar methods, for example. The rotation shaft 54D is inserted in the rod flat board portion 53B of the first rod portion 53 in a state in which the rod flat board portion 53B is inserted in the insertion groove 54C of the second rod portion 54 from a rear side. In this state, the first rod portion 53 can be swung about the rotation shaft 54D with respect to the second rod portion 54 in a direction perpendicular to the sheet surface of FIG. 5 (in the right and left direction in the state in FIG. 5).

Likewise, the rod flat board portion 54B of the second rod portion 54 is provided continuously to a front end portion of the rod circular cylindrical portion 54A. The rod flat board portion 54B is shaped like a plate having a thickness smaller than the outside diameter of the rod circular cylindrical portion 54A. The third rod portion 55 is provided in front of and next to the second rod portion 54 and shaped substantially like a circular cylinder. The third rod portion 55 has an insertion groove 55A at its central portion in the up and down direction, and this insertion groove 55A extends frontward from a rear end of the third rod portion 55. The width of the insertion groove 55A in the up and down direction corresponds to the thickness of the rod flat board portion 54B of the second rod portion 54.

A rotation shaft 55B is inserted in a rear end portion of the third rod portion 55. The rotation shaft 55B extends through the insertion groove 55A in the up and down direction. Opposite end portions of the rotation shaft 55B in its axial direction are fixed to the third rod portion 55. The opposite ends of the rotation shaft 55B in the axial direction are fixed to the third rod portion 55 by welding, pressing, or other similar methods, for example. The rotation shaft 55B is inserted in the rod flat board portion 54B of the second rod portion 54 in a state in which the rod flat board portion 54B is inserted in the insertion groove 55A of the third rod portion 55 from a rear side. In this state, the second rod portion 54 can be swung about the rotation shaft 55B with respect to the third rod portion 55 in a direction perpendicular to the sheet surface of FIG. 5.

### Construction of Distal End Portion of Neck 13

There will be next explained a construction of a front end portion of the neck 13. As illustrated in FIG. 1, the string engaging portion 71 is mounted on an upper surface of a front end portion of the second neck portion 43. Second end portions 15B of the respective strings 15 are engaged with the string engaging portion 71. Six pins 73 are provided on the string engaging portion 71 at positions at which the respective strings 15 are tensioned. Nuts 75 each for keeping the height level of a corresponding one of the strings 15 are provided on an upper surface of a front end portion of the second fingerboard 51B. The second end portions 15B of the respective strings 15 are inserted in the respective pins 73 via the respective nuts 75. Fastening screws 77 (e.g., hexagon head screws) are inserted in the respective pins 73 in the up and down direction. When each of the fastening screws 77 is tightened, a corresponding one of the pins 73 engages the second end portion 15B of a corresponding one of the strings 15 with the front end portion of the second neck portion 43.

The neck fastening mechanism 47 is mounted on a front end surface 43C (see FIG. 6) of the second neck portion 43. FIG. 6 is a perspective view of the guitar 10 viewed from a front upper side, and FIG. 6 illustrates a state in which the neck 13 is locked by the neck fastening mechanism 47. It is noted that FIG. 6 omits illustration of the strings 15, the string engaging portion 71, the first neck portion 41, and other components for simplicity.

As illustrated in FIG. 6, the neck fastening mechanism 47 includes a shaft 81 and a handle 83. As will be described below, the neck fastening mechanism 47 is rotated with respect to the rod 45. Thus, the orientation (angle) of the neck fastening mechanism 47 illustrated in FIG. 6 is one example and changed as needed in accordance with its rotational position.

The shaft 81 is shaped like a circular cylinder extending along a direction parallel with the right and left direction. The shaft 81 has an insertion hole 81A at its central portion in the right and left direction. The third rod portion 55 of the rod 45 is to be inserted in the insertion hole 81A. The insertion hole 81A is formed through the shaft 81 in a direction parallel with the front and rear direction. An engaged portion, not illustrated, is formed in the insertion hole 81A. The third rod portion 55 is to be engaged with this engaged portion. A front end portion of the third rod portion 55 has an engaging portion 55C with a thread corresponding to a pitch of the engaged portion formed in the insertion hole 81A. When engaged with the engaging portion 55C, the shaft 81 is rotatable about a central axis X1 of the third rod portion 55. A distal end of the engaging portion 55C has a chamfered portion 55D chamfered and rounded to facilitate the insertion of the rod 45 into the insertion hole 81A, the third cylindrical member 67, and the second cylindrical member 65.

Handle rotation shafts 81B are provided on the shaft 81 so as to protrude outward in the axial direction of the shaft 81 (the right and left direction in the state in FIG. 6) respectively from opposite end surfaces of the shaft 81 in the axial direction. Each of the handle rotation shafts 81B is shaped like a circular cylinder having a diameter less than that of a main body portion of the shaft 81. A central axis X2 of the handle rotation shafts 81B coincides with that of the main body portion of the shaft 81.

The handle 83 includes a pair of arms 85 and a holding portion 87. Each of the arms 85 has a bearing 85A provided in its upper end portion. The handle rotation shafts 81B are inserted in the respective arms 85, whereby the arms 85 are swingable about the central axis X2. Each of the arms 85 has a predetermined thickness in the right and left direction and extends downward from a corresponding one of the bearings 85A. The length of each of the arms 85 in the front and rear direction decreases with increase in distance from an upper end of the arm 85.

In the state illustrated in FIG. 6, a distance L1 from the central axis X2 to a front end of each of the bearings 85A is greater than a distance L2 from the central axis X2 to a rear end of the bearing 85A. In other words, the bearing 85A has such a shape that the center of gravity of the bearing 85A is nearer to one of opposite ends of the bearing 85A (a rear end of the bearing 85A) from the central axis X2 than the other. Thus, the bearing 85A is swung with a swing of the handle 83 in a state in which the bearing 85A is eccentric. In the state illustrated in FIG. 6, outer circumferential surfaces 85C of portions of the respective bearings 85A which protrude rearward press the front end surface 43C of the second neck portion 43. With this construction, the second neck portion 43 is pressed by the handle 83 and thereby locked toward the first neck portion 41 and the body 11.

The holding portion 87 is attached to front surfaces 85B of the respective arms 85. The holding portion 87 is shaped like a plate extending along the flat front surfaces 85B. The holding portion 87 is provided so as to extend from substantially central portions of the front surfaces 85B to lower end portions of the front surfaces 85B in the up and down direction. Thus, the two arms 85 are coupled to each other by the holding portion 87 so as to be rotated as a unit.

### Disassembling Procedure

There will be next explained one example of a procedure of disassembling the guitar 10 having the above-described construction. (1) First, the user swings the second body portion 22 with respect to the first body portion 21 in the state illustrated in FIG. 1 to loosen the strings 15. The swing of the second body portion 22 swings the bridge 23 in a direction toward the first body portion 21 (see the arrow 29 in FIG. 3). The strings 15 are loosened by the swing of the bridge 23.

(2) The user then unlocks the neck fastening mechanism 47 provided at a front end portion of the guitar 10. For example, the user holds the holding portion 87 with his or her hand and swings the handle 83 upward in a direction indicated by arrow 91 illustrated in FIG. 6. Swing of the bearings 85A reduces the distance L2 from the central axis X2 to the rear ends of the bearings 85A. This reduces a force with which the outer circumferential surfaces 85C press the front end surface 43C. For example, when the handle 83 is swung to a horizontal position at which the handle 83 extends along the front and rear direction, the neck fastening mechanism 47 is unlocked.

(3) The user then rotates the neck fastening mechanism 47 about the central axis X1 of the rod 45 (see FIG. 6) in a direction in which the neck fastening mechanism 47 is loosen with respect to the engaging portion 55C of the third rod portion 55. In this operation, the neck fastening mechanism 47 moves frontward relative to the rod 45 while rotating.

(4) The user then removes the neck fastening mechanism 47 from the rod 45 and then removes the rod 45 from the first body portion 21. When pivotal movement of the third rod portion 55 is performed about the central axis X1, the engaging portion 53C of the first rod portion 53 is removed from the nut 63 of the first body portion 21. It is noted that the third rod portion 55 may include a cross-shaped handle portion provided on, e.g., a front end portion (e.g., the engaging portion 55C) of the third rod portion 55 to make it easier for the user to rotate the rod 45. After removing the first rod portion 53 from the nut 63, the user pulls the rod 45 frontward out of the first body portion 21 and the neck 13. The rod 45 pulled out is pivotable about the rotation shaft 54D and the rotation shaft 55B to fold the rod 45 in three, resulting in size of the rod 45.

(5) The user then pulls the joint rods 43B of the second neck portion 43 out of the respective joint holes 41F of the first neck portion 41. As a result, the second neck portion 43 is separated from the first neck portion 41. The user then removes the protrusion 41C of the first neck portion 41 from the recess 21C of the first body portion 21. As a result, the first neck portion 41 is separated from the body 11. Thus, the guitar 10 is disassembled into the body 11, the first neck portion 41, the second neck portion 43, the rod 45, and the neck fastening mechanism 47. The disassembled components can be gathered together to make them compact, resulting in increase in portability and storagebility. It is noted that the strings 15 may be kept attached and may be removed from the string engaging portion 71 and so on, depending upon the size of a space into which the components are to be stored.

### Assembling Procedure

There will be next explained a procedure of assembling the guitar 10. The user can assemble the guitar 10 with an assembling procedure that is principally an inverted order of the disassembling procedure. Thus, explanations of similar operations will be omitted. (1) First, the user engages the rod 45 with the nut 63 provided in the first body portion 21 to attach the rod 45 to the body 11. (2) The user then inserts the rod 45 attached to the body 11, into the second cylindrical member 65 of the first neck portion 41. The user fits the protrusion 41C into the recess 21C to attach the first neck portion 41 to the first body portion 21. (3) The user inserts the rod 45 into the third cylindrical member 67 of the second neck portion 43. The user fits the joint rods 43B into the respective joint holes 41F to attach the second neck portion 43 to the first neck portion 41.

(4) The user engages the neck fastening mechanism 47 with the engaging portion 55C of the third rod portion 55 protruding frontward from the second neck portion 43. In this operation, the user engages the neck fastening mechanism 47 with the engaging portion 55C until the outer circumferential surfaces 85C of the arms 85 are moved to a position near the front end surface 43C of the second neck portion 43 or brought into contact with the front end surface 43C. (5) The user swings the handle 83 in a direction indicated by arrow 93 illustrated in FIG. 6 to press the neck 13 against the body 11 by the bearings 85A of the respective arms 85, thereby securing the neck 13 to the body 11. Finally, the user swings the second body portion 22 downward with respect to the first body portion 21. As a result, the guitar 10 is changed to the state in FIG. 1.

The guitar 10 is one example of a stringed musical instrument. The recess 21C is one example of a second recess. The protrusion 41C is one example of a second protruding portion. Each of the joint rods 43B is one example of a first protruding portion. Each of the joint holes 41F is one example of a first recess. The first rod portion 53, the second rod portion 54, and the third rod portion 55 are one example of a plurality of divided rod portions. The insertion groove 54C and the rotation shaft 54D are one example of a connector. The engaging portion 53C is one example of a first engaging portion. The engaging portion 55C is one example of a second engaging portion. The nut 63 is one example of a first engaged portion. Each of the first to third cylindrical members 61, 65, 67 is one example of a cylindrical member. The string engaging portion 71 is one example of a neck-side engaging portion. The shaft 81 is one example of an engaging portion or a fastened portion. The handle 83 is one example of a pressing portion.

The embodiment described above achieves the following effects. The neck 13 is disassemblable in the front and rear direction (the direction in which the neck 13 extends) into the first neck portion 41 to be attached to the first body portion 21 and the second neck portion 43 to be attached to the first neck portion 41. The first neck portion 41, the second neck portion 43, and the first body portion 21 respectively include the first to third cylindrical members 61, 65, 67 for insertion of the rod 45. In the present guitar 10, the rod 45 is inserted through the cylindrical members (e.g., the first cylindrical member 61) provided in the three components, thereby enabling assembly of the three components so as to couple the components to each other. Also, in the present guitar 10, it is possible to disassemble the first neck portion 41 and the second neck portion 43 by pulling the rod 45 out of, e.g., the first cylindrical member 61 in the assembled state. Accordingly, the user can pull out the rod 45 and disassemble the neck 13 into the first neck portion 41 and the second neck portion 43, thereby making the entire guitar 10 compact.

The rod 45 is constituted by the three components (the first rod portion 53, the second rod portion 54, and the third rod portion 55) coupled to each other. The rod is pivotable about the rotation shafts 54D, 55B to fold the rod in three, thereby making the rod compact.

Here, a portion of the neck 13 at which the first neck portion 41 and the second neck portion 43 are coupled to each other is located at a boundary of two portions of the neck 13 into which the neck 13 is divided. Thus, there is a possibility that the stiffness of the coupled portion is lower than that of the other portion of the neck 13. Likewise, since a portion of the rod 45 at which the first rod portion 53 and the second rod portion 54 are coupled is pivotable by the rotation shaft 54D, there is a possibility that the stiffness of the coupled portion is lower than that of the other portion of the rod 45. Likewise, there is a possibility that the stiffness of a portion of the rod 45 at which the second rod portion 54 and the third rod portion 55 are coupled to each other is lower than that of the other portion of the rod 45. In contrast, the rod 45 and the neck 13 in the present embodiment are configured such that the positions of the respective coupled portions are different from each other in the front and rear direction. Specifically, for example, as illustrated in FIG. 6, the rotation shaft 55B that couples the third rod portion 55 and the second rod portion 54 to each other is disposed in the third cylindrical member 67 and located on a front side of the portion (the rear end surface 43A) at which the second neck portion 43 and the first neck portion 41 are coupled to each other, at a distance L3. Likewise, the rotation shaft 54D that couples the first rod portion 53 and the second rod portion 54 to each other is, for example, disposed in the second cylindrical member 65 and located on a front side of the rear end surface 41B of the heel 41A at a predetermined distance. Thus, the positions of the respective coupled portions are different from each other in the guitar 10, enabling the rod 45 to well increase the stiffness of the neck 13.

In the case where the rod 45 formed of metal is inserted into and removed from the neck 13 formed of wood, the neck 13 may be damaged by contact with the rod 45, for example. In the guitar 10 according to the present embodiment, in contrast, the first to third cylindrical members 61, 65, 67 formed of metal are provided in the holes for insertion of the rod 45, thereby protecting the neck 13 from contact with the rod 45.

The engaging portion 55C of the rod 45 inserted in the neck 13 is engaged with the insertion hole 81A of the shaft 81 of the neck fastening mechanism 47. The distance between the handle 83 of the neck fastening mechanism 47 and the front end surface 43C of the second neck portion 43 in the front and rear direction are changed in accordance with a position of the engagement. The handle 83 is brought close to the second neck portion 43 and swung in the direction indicated by the arrow 93 illustrated in FIG. 6. The bearings 85A of the arms 85 press the neck 13 toward the body 11 to secure the neck 13 to the body 11. With this construction, the user can swing the handle 83 to reduce relative positional misalignment among the rod 45, the neck 13, and the body 11.

The body 11 are divided into the first body portion 21 and the second body portion 22 which are coupled to each other by the swing member 27. With a swing of the swing member 27, the second body portion 22 is swung with respect to the first body portion 21 in the direction indicated by the arrow 29 in FIG. 3. With this construction, the user can swing the second body portion 22 to loosen the strings 15, enabling easy disassembly of the neck 13.

The guitar 10 according to the present embodiment does not include a head having pegs at a distal end of the second neck portion 43, and tension of the strings 15 is adjustable by the bridge 23 provided on the body 11. This construction can reduce a volume after disassembly of the neck 13, enabling further size reduction.

The pressing force applied from the bearings 85A to the second neck portion 43 is changed in accordance with a position at which the shaft 81 of the neck fastening mechanism 47 is engaged with the engaging portion 55C. For example, in the case where the handle 83 is swung at a position spaced apart from and located in front of the front end surface 43C of the second neck portion 43, the pressing force is relatively small. In the case where the handle 83 is swung in the state in which the outer circumferential surfaces 85C of the bearings 85A are in contact with the front end surface 43C, the pressing force is relatively large. With this construction, in the case where the neck 13 is curved by tension of the strings 15, the curve of the neck 13 can be corrected by changing the position and so on of the neck fastening mechanism 47.

The rod 45 and the first to third cylindrical members 61, 65, 67 formed of metal is higher in specific gravity than the neck 13 formed of wood, giving greater effect on the quality of sound produced by the guitar 10. In the guitar 10 according to the present embodiment, in contrast, acoustic characteristics of the guitar 10 can be changed by replacing the rod 45 with another one having a material, a shape, a size, the number and/or the like which is different from that of the rod 45. For example, the rod 45 formed of a heavier metal material can be used to easily produce high-order overtones. Conversely, the rod 45 formed of a lighter metal material can be used to easily reduce production of high-order overtones.

The total weight of the body 11 can be made heavier than the rod 45 and the first to third cylindrical members 61, 65, 67 to reduce deviation of the center of gravity of the guitar 10 due to change in the mass of, e.g., the rod 45. Thus, even in the case where the mass of, e.g., the rod 45 is changed by change in its material or the like, it is possible to reduce lowering of playability due to the deviation of the center of gravity of the guitar 10.

The user can easily disassemble the guitar 10 according to the present embodiment without any specific tools. In the guitar 10 according to the present embodiment, the entire length of the neck 13 can be changed by changing the size and the number of the attachable and removable first neck portion 41 and second neck portion 43. With this construction, the guitar 10 according to the present embodiment can achieve a guitar with a long string length and a guitar with a short string length. Likewise, various stringed musical instruments are enjoyable by replacing the attachable and removable body 11 with a body of another one of stringed musical instruments (e.g., acoustic guitars, violins, and ukuleles). In this case, since the violins and the ukuleles do not include the rod 45 in the neck 13 in general, the neck 13 not including the rod 45 may be installed in the case where the body 11 is replaced with a body of the violin, for example.

It is to be understood that the disclosure is not limited to the details of the illustrated embodiment, but may be embodied with various changes and modifications, which may occur to those skilled in the art, without departing from the spirit and scope of the disclosure. For example, though not particularly mentioned in the above-described embodiment, as illustrated in FIGS. 2 and 3, the body 11 may include a restrainer 28 for restraining a swing of the second body portion 22 with respect to the first body portion 21. More specifically, the restrainer 28 is mounted on a lower end of the second body portion 22 slidably in the front and rear direction in the state illustrated in FIG. 2. The restrainer 28 is movable between a lock position at which the restrainer 28 is inserted in a restraining hole 28A formed in the first body portion 21 and an unlock position at which the restrainer 28 slid rearward from the lock position is pulled out of the restraining hole 28A. In the case where the user wants to bend the body 11, for example, the user operates a knob 28B provided on the restrainer 28 to slide the restrainer 28 rearward and pulls the restrainer 28 out of the restraining hole 28A to undo the lock. As a result, the restraint of the second body portion 22 by the restrainer 28 is canceled, enabling a swing of the second body portion 22 with respect to the first body portion 21. This construction can more reliably prevents the swing of the second body portion 22 with respect to the first body portion 21 to prevent a malfunction such as bending of the guitar 10 during playing.

In the above-described embodiment, the neck 13 is disassemblable into three or more neck portions. In the above-described embodiment, the body 11 can be divided into the first body portion 21 and the second body portion 22, but the present disclosure is not limited to this construction. For example, the body 11 may be constituted by a single member and not be swung. In this case, the swing member 27 is not required. The protrusion 41C provided on the first neck portion 41 is fitted in the recess 21C formed in the first body portion 21 in the above-described embodiment, but conversely the guitar may be constructed such that the recess 21C is formed in the first neck portion 41, and the protrusion 41C is provided on the first body portion 21. The joint rods 43B provided on the second neck portion 43 are fitted in the respective joint holes 41F of the first neck portion 41 in the above-described embodiment, but conversely the guitar may be constructed such that the joint rods 43B are provided on the first neck portion 41, and the joint holes 41F are formed in the second neck portion 43. The joint rods 43B and the joint holes 41F may be used as a structure for coupling the first neck portion 41 and the first body portion 21 to each other. Likewise, the protrusion 41C and the recess 21C may be used as a structure for coupling the first neck portion 41 and the second neck portion 43 to each other. The protrusion 41C and the recess 21C, and the joint rods 43B and the joint holes 41F may be combined for one coupled portion, e.g., a portion at which the first neck portion 41 and the first body portion 21 are coupled to each other. Also, one or more joint rods 43B and/or two or more protrusions 41C may be used for one coupled portion. The coupling structure may be another structure. For example, the recess may have a dovetail groove shape, and a protrusion having a dovetail shape may be fitted in the recess having the dovetail groove shape.

In the above-described embodiment, the guitar 10 including the rod 45 in the neck 13 is one example of the stringed musical instrument, but the present disclosure is not limited to this construction. The stringed musical instrument according to the present disclosure may be a stringed musical instrument (e.g., a violin) not including the rod 45 in the neck 13. The rod 45 is foldable in three in the above-described embodiment but may be foldable in two, or four or more. The rod 45 may be one rod not foldable. While the rod 45 is configured such that the first rod portion 53, the second rod portion 54, and the third rod portion 55 are rotatable relative to each other by the rotation shaft 54D in the above-described embodiment, but the present disclosure is not limited to this configuration. The first to third rod portions 53-55 at least needs to be connected to each other so as not to be separated from each other in the state in which the first to third rod portions 53-55 are inserted in the first neck portion 41 and the second neck portion 43. For example, the guitar 10 may be constructed such that an engaging portion and a non-engaging portion are respectively provided at two rod portions and engaged with each other such that the two rod portions are not separated from each other. The plurality of rod portions constituting the rod 45 may be separated from each other when the plurality of rod portions are not connected to each other. In the above-described embodiment, the rod 45 is a rod member having a substantially circular cylindrical shape, but the present disclosure is not limited to this construction. For example, the rod 45 may be a member shaped like a plate. The coupled portion of the rod 45 and the coupled portion of the neck 13 are different from each other in position in the above-described embodiment but may be the same as each other in position.

While the rod 45 is secured by engagement with the nut 63 of the body 11 in the above-described embodiment, a method of securing the rod 45 to the body 11 is not limited to this construction. For example, an end portion of the body 11 near the rod 45 may have a hole for insertion of a bolt engaged from a lower surface of the body 11. This construction enables the rod 45 to be secured to the body 11 by engaging the bolt from the lower surface of the body 11. While the rod 45 is inserted into the body 11 from a front side thereof in the above-described embodiment, the present disclosure is not limited to this construction. For example, the rod 45 may be inserted from a rear side of the first body portion 21 (e.g., the rear end surface 21A) to secure the rod 45 to the first body portion 21. In the above-described embodiment, the first body portion 21, the first neck portion 41, and the second neck portion 43 may not include the respective first to third metal cylindrical members 61, 65, 67 at the insertion holes for insertion of the rod 45. At least one of the first neck portion 41, the second neck portion 43, and the first body portion 21 may include a metal cylindrical member.

In the above-described embodiment, the construction of the neck fastening mechanism 47 that secures the rod 45 and the neck 13 to each other is one example. For example, the neck fastening mechanism may be a cap member engageable with the engaging portion 55C of the rod 45 and shaped like a cylinder having a closed bottom. For example, the user can tighten this cap on the distal end of the engaging portion 55C to press the cap against the front end surface 43C. The neck fastening mechanism 47 may be secured to the rod 45. For example, the third rod portion 55 secured in the insertion hole 81A of the shaft 81. In this construction, for example, the user can hold the handle 83 and rotate the rod 45 about the central axis X1 to remove the rod 45 from the nut 63 of the body 11. Also, the user can hold and pull the handle 83 frontward to remove the rod 45 from the first to third cylindrical members 61, 65, 67. Thus, the user can easily perform operations for removing the rod 45. In the above-described embodiment, the second neck portion 43 of the guitar 10 may be provided with a head with pegs, around which the respective strings 15 are wound. In this case, the guitar is tunable with the pegs provided on the head. Thus, the bridge 23 of the body 11 may have a structure for simply engaging with the first end portion 15A without having a structure for adjusting the tension of the strings 15.

### EXPLANATION OF REFERENCE NUMERALS

10: Guitar (Stringed Musical Instrument), 11: Body, 13: Neck, 21: First Body Portion, 21C: Recess, 22: Second Body Portion, 23: Bridge, 27: Swing Member, 33: Tension Adjusting Screw, 41: First Neck Portion, 41C: Protrusion, 41F: Joint Hole, 43: Second Neck Portion, 43B: Joint Rod, 45: Rod, 47: Neck Fastening Mechanism, 53: First Rod Portion, 53C: Engaging Portion (First Engaging Portion), 54: Second Rod Portion, 55: Third Rod Portion, 55C: Engaging Portion (Second Engaging Portion), 54D, 55B: Rotation Shaft, 61, 65, 67: First to Third Cylindrical Members (Cylindrical Members), 63: Nut (First Engaged Portion), 71: String Engaging Portion (Neck-side Engaging Portion), 81: Shaft, 81B: Handle Rotation Shaft, 83: Handle

1. A stringed musical instrument, comprising:
a body;
a neck extending from the body in one direction, a string being tensioned at the neck, the string comprising a first end portion and a second end portion, the body holding the first end portion of the string, the neck holding the second end portion of the string; and
a rod provided in the neck and extending in a direction in which the neck extends,
wherein the neck comprises: a first neck portion to be held by the body; and a second neck portion provided on an opposite side of the first neck portion from the body in the direction in which the neck extends, the second neck portion holding the second end portion of the string, the second neck portion being attachable to and detachable from the first neck portion, and
wherein each of the first neck portion, the second neck portion, and the body is formed with an insertion hole in which the rod is insertable in the direction in which the neck extends.

2. The stringed musical instrument according to claim 1,
wherein the rod comprises: a plurality of divided rod portions extending in the direction in which the neck extends; and a connector configured to connect the plurality of divided rod portions to each other, and
wherein the rod is inserted in the insertion hole in a state in which the plurality of divided rod portions are connected to each other by the connector.

3. The stringed musical instrument according to claim 2, wherein the connector is configured to connect the plurality of divided rod portions to each other such that the plurality of divided rod portions are not separated from each other in a state in which the plurality of divided rod portions are inserted in the insertion hole.

4. The stringed musical instrument according to claim 1, wherein the rod comprises: a first rod portion extending in the direction in which the neck extends; a rotation shaft provided at one end portion of the first rod portion in the direction in which the neck extends, the rotation shaft being insertable in the first rod portion in a direction perpendicular to the direction in which the neck extends; and a second rod portion extending in the direction in which the neck extends, the second rod portion being pivotably held by the rotation shaft at the one end portion of the first rod portion.

5. The stringed musical instrument according to claim 2, wherein the rotation shaft is disposed on one side, in the direction in which the neck extends, of a portion at which the first neck portion and the second neck portion are coupled to each other, in a state in which each of the first rod portion and the second rod portion is inserted in the insertion hole.

6. The stringed musical instrument according to claim 1,
wherein the body comprises a first engaged portion, and
wherein the rod comprises a first engaging portion provided at one of opposite end portions of the rod, which one is nearer to the body than the other, and the first engaging portion is engaged with the first engaged portion in a state in which the rod is inserted in the insertion hole of the body.

7. The stringed musical instrument according to claim 1,
wherein the rod is formed of a metal material, and
wherein at least one of the first neck portion, the second neck portion, and the body comprises a cylindrical member secured in the insertion hole and formed of a metal material, and the rod is insertable in the cylindrical member.

8. The stringed musical instrument according to claim 1, further comprising a neck fastening mechanism provided on one of opposite end portions of the neck in the direction in which the neck extends, which one is farther from the body than the other in the direction in which the neck extends,
wherein the rod comprises: a first engaging portion provided on one of opposite end portions of the rod, which one is nearer to the body than the other, the first engaging portion being engageable with a first engaged portion formed at the body; and a second engaging portion provided on the other of the opposite end portions of the rod, which is farther from the body than the one, the second engaging portion being engageable with a second engaged portion formed at the neck fastening mechanism, and
wherein the neck fastening mechanism comprises: an engaging portion at which the second engaged portion is formed; and a pressing portion configured to press the neck toward the body in a state in which the first engaging portion is engaged with the first engaged portion, and the second engaging portion is engaged with the second engaged portion.

9. The stringed musical instrument according to claim 8,
wherein the engaging portion comprises a shaft having a columner shape and extending in a direction perpendicular to the direction in which the neck extends, the shaft comprising a handle rotation shaft protruding outward from each of end faces of the shaft in an axial direction of the shaft, and
wherein the pressing portion comprises a handle swingably held by the handle rotation shaft, the handle being eccentric with respect to the handle rotation shaft, the handle being configured to press the second neck portion toward the first neck portion.

10. The stringed musical instrument according to claim 1, further comprising a neck fastening mechanism provided at one of opposite end portions of the second neck portion in the direction in which the neck extends, the other of the opposite end portions being to be held by the first neck portion, and
wherein the neck fastening mechanism comprises: a fastened portion to be fastened to one of opposite end portions of the rod, which one is nearer to the second neck portion than the other; and a pressing portion configured to press the neck toward the body in a state in which the fastened portion is fastened to the one of the opposite end portions of the rod, which one is nearer to the second neck portion than the other.

11. The stringed musical instrument according to claim 10,
wherein the fastened portion comprises a shaft having a columner shape and extending in a direction perpendicular to the direction in which the neck extends, the shaft comprising a handle rotation shaft protruding outward from each of end faces of the shaft in an axial direction of the shaft, and
wherein the pressing portion comprises a handle swingably held by the handle rotation shaft, the handle being eccentric with respect to the handle rotation shaft, the handle being configured to press the second neck portion toward the first neck portion.

12. A stringed musical instrument, comprising:
a body; and
a neck extending from the body in one direction, a string being tensioned at the neck, the string comprising a first end portion and a second end portion, the body holding the first end portion of the string, the neck holding the second end portion of the string,
wherein the neck comprises: a first neck portion held by the body; and a second neck portion provided on an opposite side of the first neck portion from the body in a direction in which the neck extends, the second neck portion holding the second end portion of the string, the second neck portion being attachable to and detachable from the first neck portion,
wherein one of the first neck portion and the second neck portion comprises a first protruding portion protruding toward the other of the first neck portion and the second neck portion, and
wherein the other of the first neck portion and the second neck portion comprises a first recess in which the first protruding portion is fittable.

13. The stringed musical instrument according to claim 1,
wherein one of the body and the first neck portion comprises a second protruding portion protruding toward the other of the body and the first neck portion, and
wherein the other of the body and the first neck portion comprises a second recess in which the second protruding portion is fittable.

14. The stringed musical instrument according to claim 1, wherein the body comprises: a first body portion configured to hold the first neck portion; a second body portion provided on an opposite side of the first body portion from the first neck portion in the direction in which the neck extends; a bridge provided at the second body portion and configured to be engaged with the first end portion of the string;
and a swing member configured to couple the first body portion and the second body portion to each other and hold the second body portion such that the second body portion is swingable relative to the first body portion, from a state in which the string is tensioned, in a direction in which the bridge is brought closer to the first body portion.

15. The stringed musical instrument according to claim 14,
wherein the second neck portion comprises a neck-side engaging portion provided at one of opposite end portions of the second neck portion in the direction in which the neck extends, the other of the opposite end portions being to be held by the first neck portion, the neck-side engaging portion being configured to be engaged with the second end portion of the string, and
wherein the bridge comprises: a main body portion; and a tension adjusting screw engaged with the first end portion of the string and configured to adjust tension of the string in accordance with a position at which the tension adjusting screw is engaged with the main body portion.
